(19) United States
(12) Patent Application Publication
(10) Pub. No.: US 2022/0372174 A1
(43) Pub. Date: Nov. 24, 2022

(54) SOLUBLE CORN STEEP

(71) Applicant: ROQUETTE FRERES, LESTREM (FR)

(72) Inventors: Baptiste BOIT, LA Gorgue (FR); Matthieu RAMETTE, Arras (FR); Antoine SALOME, Willerval (FR); Fabrice BUQUET, Renescure (FR)

(21) Appl. No.: 17/754,976

(22) PCT Filed: Oct. 16, 2020
(86) PCT No.: PCT/FR2020/051860

§ 371 Date: Apr. 18, 2022

(30) Foreign Application Priority Data
Oct. 18, 2019 (FR) FR19 11683

(51) Int. Cl. C08B 30/10; C08B 30/06

(52) U.S. Cl. CPC C08B 30/10; C08B 30/06

(57) ABSTRACT

The present invention relates to a process for treating a corn steep solution, which makes it possible to obtain a corn steep solution which may readily be atomized and which remains soluble after sterilization. The present invention also relates to the corn steep powder which may be obtained via this process.

### TECHNICAL FIELD

The present invention relates to a process for treating a corn steep solution, which makes it possible to obtain a corn steep solution which may readily be atomized and which remains soluble after sterilization. The present invention also relates to the corn steep powder which may be obtained via this process.

### PRIOR ART

The term “corn steep liquor”, which is a term frequently used by those skilled in the art, means the concentrated steeping water resulting from steeping corn.

Steeping corn in water is the first step in the extraction of starch during wet starch processing. This steeping step allows the corn grains to swell and the highly fermentable soluble matter, contained in these grains, to be discarded. It consists in maintaining the corn placed in silos for a given time in warm water which contains a small amount of sulfur dioxide, in order to facilitate the subsequent protein-cellulose-starch separation, and also to prevent the growth of undesirable microorganisms.

Two essential phenomena take place simultaneously during steeping: the first one consists of the diffusion of soluble matter of the corn grains into the steeping water, while the second one consists of fermentation of this soluble matter in the steeping water by lactic acid bacteria, the steeping conditions (presence of sulfites, of reducing sugars, temperature) being favourable to the rapid development of this bacterial flora.

The main advantage of this concentrated steeping water, usually called “corn steep liquor” by those skilled in the art, resides in its composition in essential nutrients, resulting from the transfer of the soluble matter from the grains. These nutrients constitute factors that are favourable to the growth of microorganisms and also to the production of secondary metabolites, and make corn steep liquor an ideal source of nutritive substances for the fermentation industry.

Specifically, corn steep liquor is an organic nitrogen source of choice due to the distribution and forms of its amino acids: free, peptide or protein forms, and also a source of carbon (lactic acid) and phosphate (phytic acid) with a delay effect. A high content of vitamins and trace elements adds to the interest that corn steep liquor represents as a nutrient source for the growth of microorganisms and the induction of secondary metabolites when corn steep liquor is combined with one or more sources of carbon (glucose, maltodextrin, starch, sucrose, etc.).

In addition, it constitutes a nutrient source which is relatively cheap when compared with yeast extracts which represent the reference matter in this field, and which are also used in human food and animal feed.

Moreover, it is known that the use of corn steep liquor as a replacement for complex nitrogen sources such as cotton or soybean proteins, makes it possible to substantially increase the yields of production of antibiotics.

However, corn steep liquor in liquid form gives rise to settling problems over time, which is particularly problematic for the shipping, storage and pumping of the product. Said product must be stored in stirred and temperature-controlled tanks, in order to limit the changes in its composition. This is especially true when the corn steep liquor is consumed in small quantities at a time by some fermentation industries. In this case, it is particularly important to control its preservation. The production of dry forms of corn steep liquor was then envisaged.

Spray-drying of corn steep solution is the predominantly used technology. This technique, which is very widely used in industry, enables the drying of products considered difficult to dry, such as heat-sensitive or highly hygroscopic products. However, in the case of corn steep liquor, those skilled in the art have come up against problems of sticking. Specifically, whereas the drying of some products is not at all problematic, i.e. the powder comes out evenly from the drying chamber or tower and has a satisfactory appearance and satisfactory flow properties, corn steep solution, however, being rich in amino acids and hygroscopic substances, is prone to sticking.

This sticking is manifested by deposits at various levels in the drying chamber and auxiliary equipment, these deposits giving rise to losses and to degradation of the product, which may necessitate manufacturing shutdowns with cleaning cycles which are costly in terms of time, material and labour. Sticking may also occur after the drying step, when the powder, after a certain period of time in storage, loses its fluidity and forms lumps.

It is thus very difficult to atomize corn steep liquor, due to the particularly hygroscopic nature of the organic acids and of the salts contained therein, and in particular of potassium lactate which is present in high proportion (Wright K.N. Nutritional properties and feeding value of corn and its by-products. In: Corn Chemistry and Technology, pages 447-478 Watson, S. A. and Ramstad P. S. (Eds). Amer. Assoc. Cereal Chem., St Paul, Minn., USA).

The Applicant has already addressed this problem and proposed the solution described in EP 1 043 337. Advantageously, the corn steep powder according to EP 1 043 337 comprises a content of metal ions of between 1% and 5% by weight (dry/dry). This addition of metal ions makes it possible to facilitate the atomization of corn steep without any sticking. As a result, the nutritive qualities of the corn steep powder according to the invention are not only preserved, but also improved. These nutritive qualities, combined with the ease of storage and implementation, are thus understood to be an undeniable advantage, for example in the preparation of culture media for the fermentation industry.

In order to be used in the fermentation industry, this atomized corn steep liquor must be redissolved in an aqueous solvent together with all of the nutrients to be metabolized by the microbial strain whose production is desired. A precipitate appears during the resuspension step, and may account for up to 15% of the dry matter.

The amount of precipitate is amplified by the next step of sterilization of the fermentation medium. This step, aimed at removing the undesired microorganisms by the application of heating, will specifically lead a substantial formation of insoluble particles, which may represent up to 30% of the dry matter.

This problem was also investigated, in particular in the MSc thesis of E. Govender “The purification of corn steep liquor as a fermentation feedstock by ultrafiltration” published in 2010. E. Govender proposes several solutions consisting of various pretreatments such as adjusting the pH of the corn steep liquor to 7 with the addition of ammonium hydroxide, or the use of a decanter centrifuge or of gyratory screens. These pretreatments of a corn steep solution are then followed by an ultrafiltration step. However, although the pH adjustment to 7 makes it possible to reduce the amount of precipitates in the corn steep after sterilization, a large portion of the nutrients is eliminated with this pretreatment and this corn steep is not recommended for fermentation.

A person skilled in the art is still looking for a process which enables the production of a corn steep solution which can readily be atomized and which remains soluble after sterilization and can be used for fermentation purposes.

The Applicant has, to its credit, addressed all these problems and has found the inventive solution which will be more precisely described in the following chapters.

### SUMMARY

The invention consists of a process for treating a corn steep solution, comprising the following steps: a) addition of neutral salts of divalent cations, preferably magnesium or calcium salts, more preferentially calcium sulfate or magnesium sulfate, to the corn steep solution; b) adjustment of the pH of the corn steep solution to between 6 and 8, preferably by adding potassium hydroxide or ammonium hydroxide; c) separation of the liquid and solid phases of the solution obtained in step b); d) drying of the liquid phase obtained in step c), preferably by spray-drying, in order to obtain a corn steep powder. Preferably, the neutral salts of divalent cations are added to the corn steep solution which is brought to a temperature of between 20° C. and 60° C. The separation of the liquid and solid phases in step c) is preferably performed by plate centrifugation. The amount of divalent salts is preferably between 0.5 and 3.5 mol/kg of dry matter of the corn steep solution, preferably between 1 and 3 mol/kg of dry matter of the corn steep solution, even more preferentially 1.5 mol/kg of dry matter of the corn steep solution.

In another aspect, the invention relates to a corn steep powder which may be obtained by the process as described previously. Preferably, the corn steep powder is characterized in that the amount of protein is between 20% and 40%, preferably between 27% and 33% of the dry matter weight of the corn steep powder.

The invention will be better understood by means of the detailed description which may be found in the following chapters.

### BRIEF DESCRIPTION OF THE DRAWINGS

Other characteristics, details and advantages will appear on reading the description detailed below, and on analysing the attached drawings, in which:

FIG. 1 shows the experimental process for generating the corn steep solution.

FIG. 2 is a photograph of the corn steep solutions obtained in the various examples (from left to right: Example 1, 2, 4 and 3).

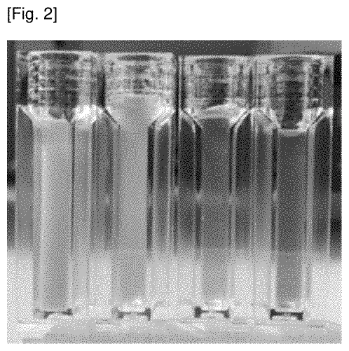

### DESCRIPTION OF THE EMBODIMENTS

The term “neutral salts of divalent cations” means any ionic compound made of divalent cations, i.e. having a positive electric charge of 2 units, and of anions, forming a product without any net electric charge.

The salt of divalent cations is said to be neutral when said salt does not influence the pH of the solution when it is dissolved.

For the purposes of the present invention, the term “corn steep liquor” or “corn steep solution” means the liquid fraction constituted of the steeping water from the silos used for steeping corn grains. The non-concentrated liquid fraction preferably has a dry matter content in the region of 15% and a content of protein nitrogen, expressed as N6.5, of about 45% by weight of dry matter, and having a phytic acid content of from 9% to 10% by weight of dry matter, a lactic acid content of from 25% to 30% by weight of dry matter, and an ash content of about 15% to 20% by weight of dry matter.

For the purposes of the present invention, the term “pulverulent” means a product having a dry matter content of greater than 95%, characterized by a size distribution profile, and an aerated, or even packed, density. The powder results from a drying step such as spray-drying (single or multiple effect spray-dryer, or spray-dryer with post-drying belt).

For the purposes of the present invention, the term “solubility” means the ability of a solid to be dissolved in a liquid solvent with the absence of insoluble particles or of turbidity.

For the purposes of the present invention, the term “sterilization” means the process step which consists in removing any microorganisms from a preparation. This technique consists in bringing to a high temperature, for example between 100° C. and 180° C., in particular at least 121° C., for at least 20 minutes.

The percentage of insoluble particles is preferentially measured by means of Test A described below:

The corn steep liquor is first adjusted to pH 7 ±0.5 with HCI and NaOH.
200 g of the corn steep liquor are placed in a 500 ml conical flask closed with a foam stopper covered with aluminium foil.

The conical flask is sterilized using a wet steam autoclave, following a schedule of 20 minutes at 121° C.
The corn steep liquor is then filtered through a cellulose acetate filter with a porosity of 0.22 micron, the weight of which is known.
The filter is freeze-dried, then its weight is measured.

Percentage of insoluble particles (in %)=((weight of dried final filter−weight of initial filter)/initial weight of corn steep solution)×100.

A subject of the present patent application is a process for treating a corn steep solution, which makes it possible to obtain a corn steep liquor which can readily be spray-dried and which remains soluble after sterilization, comprising the following steps:
a) addition of a neutral salt of divalent cations to the corn steep solution;
b) adjustment of the pH of the corn steep solution to a value of between 6 and 8;
c) separation of the liquid and solid phases of the solution obtained in step b);
d) drying of the liquid phase obtained in step c) in order to obtain a corn steep powder.

The first step of the process consists of the addition of a neutral salt of divalent cations to the corn steep solution. Any commercial corn steep solution may be used for this purpose.

Preferably, the corn steep solution is produced from corn grains by a process conventionally used in the prior art known as the “steeping” of corn. As described earlier in the description, steeping of corn in water is the first step of the extraction of starch during wet starch processing. This steeping step allows the corn grains to swell and the highly fermentable soluble matter, contained in these grains, to be discarded. It consists in maintaining the corn placed in silos for a given time in warm water which contains a small amount of sulfur dioxide, in order to facilitate the subsequent protein-cellulose-starch separation, and also to prevent the growth of undesirable microorganisms.

Two essential phenomena take place simultaneously during steeping: the first one consists of the diffusion of soluble matter of the corn grains into the steeping water, while the second one consists of fermentation of this soluble matter in the steeping water by lactic acid bacteria, the steeping conditions (presence of sulfites, of reducing sugars, temperature) being favourable to the rapid development of this bacterial flora.

Preferably, a person skilled in the art may use the teachings of U.S. Pat. No. 4 359 528 or those described in patent applications EP 724 841 and EP 819 702 belonging to the Applicant.

Preferably, the dry matter of the corn steep solution is between 5% and 25% of dry matter, preferentially between 10% and 20%, more preferentially 15%.

A neutral salt of divalent cations is added to the corn steep solution.

Preferably, magnesium or calcium salts are used. In order to avoid a whitish salt precipitate containing, inter alia, tricalcium phosphate in a fermentation medium containing phosphorus and/or potassium, magnesium salts are preferred. Among the neutral magnesium salts, magnesium sulfate is highly preferred.

The amount of neutral salts of divalent cations, preferentially of magnesium salts, even more preferentially magnesium sulfate, added to the corn steep solution is between 0.5 and 3.5 mol/kg of corn steep solution dry matter, preferably between 1 and 3 mol/kg of corn steep solution dry matter, even more preferentially 1.5 mol/kg of corn steep solution dry matter. The amount of neutral salts of divalent cations is to be understood in the present invention as the amount of anhydrous salt.

An additional amount of salts may be added. The product will operate in the same manner as regards the sterilization stability and fermentation performance. However, an increased salt content will be a drawback for the fermentation industries.

In an even more preferred manner, the concentration of magnesium sulfate heptahydrate is between 4% and 8% by dry weight of magnesium sulfate heptahydrate relative to the weight of dry corn steep, preferentially between 4% and 6%, even more preferentially 4.5%

The neutral salt of divalent cations, preferentially neutral magnesium salts, even more preferentially magnesium sulfate, may be added to the corn steep solution in powder form or in a form prediluted in an aqueous solvent.

After the addition of the salt of divalent cations, a stirring step is recommended for obtaining homogeneous distribution of the neutral salt of divalent cations as defined previously in the corn steep solution. This stirring step is conventionally performed in a suitable container (tank, etc.) equipped with a stirring system, e.g. a rotary axle equipped with impellers.

The addition is preferentially performed with a modification of the temperature of the corn steep solution to between 20° C. and 60° C., preferentially between 30° C. and 50° C., even more preferentially 40° C. To this end, any temperature regulating system may be used, for instance the use of a heat exchanger of “coil” type which is fed with hot water or steam.

The second step of the process of the invention consists in neutralizing the pH of the corn steep solution, i.e. in adjusting the pH of the corn steep solution to a pH of between 6 and 8, preferentially between 6.5 and 7.5, even more preferentially 7.

To perform this step, a person skilled in the art may add to the corn steep solution any basic reagent well known in the prior art.

Preferably, this basic reagent will be chosen from the group consisting of potassium hydroxide and ammonium hydroxide. The use of ammonium hydroxide is advantageous as it allows a little more nitrogen to be supplied for the fermentation. However, it gives a final product which has a pH that is slightly more acidic, which necessitates a potential initial pH adjustment by the user. The use of potassium hydroxide makes it possible to avoid this final pH variation.

As for the first step, the pH adjustment is performed with stirring while regulating the temperature of the solution. The equipment will be of the same nature as that used in the preceding step (tank with stirring and temperature regulation).

Thus, in one particular embodiment, the addition of magnesium salt of the first step and the pH adjustment of the second step may be performed together.

Preferably, the temperature of the corn steep solution during the pH adjustment is between 15° C. and 25° C., preferentially 20° C.

Preferably, during the pH adjustment, the corn steep solution is subjected to stirring, in order to allow the formation of insoluble compounds. The stirring time is preferably between 1 min and 60 min, preferentially between 10 min and 50 min, even more preferentially between 20 min and 40 min.

The third step consists in separating the liquid and solid phases of the solution obtained in the preceding step.

To this end, a person skilled in the art may use any well-known technique, including filtration (cross-flow, membrane, dead-end filtration, etc.) and sedimentation (static, centrifugal sedimentation, etc.).

Preferably, a person skilled in the art will use centrifugal separation and in particular the “plate” centrifuge technology.

The solid phase, also called sludge or sediment, generally contains from 30% to 50% dry/dry of mineral ash, the remainder predominantly being made of phytic acid, lactic acid and proteins. This sludge contains about 50% of the proteins initially contained in the corn steep solution. This loss is a result of the increased stability of the supernatant fraction.

The liquid phase, also called the supernatant, concentrates the remainder of the soluble compounds.

The liquid phase of the liquid corn steep has increased stability towards heat treatment, and improved atomization. The fermentation performance is moreover maintained when using this liquid phase.

The last step consists in drying the liquid phase obtained in the preceding step in order to obtain a corn steep powder.

To this end, a person skilled in the art may use any technique well known in the prior art.

The Applicant has demonstrated that the corn steep powder in accordance with the invention may be advantageously manufactured, for example by using an atomizing tower of Niro type, preferably a multiple effect atomizing tower.

An air inlet temperature of between 150° C. and 250°, and flow rates of entering matter such that the temperature of the air exiting the tower is between 60° C. and 100° C., may advantageously be chosen.

The corn steep powder obtained according to the process in accordance with the invention may then be formed as tablets, for example using an alternating press in the presence of lubricant.

In a preferred embodiment, the percentage of dry matter of the corn steep powder according to the invention is greater than 80%, preferentially greater than 85%, even more preferentially greater than 90%.

The dry matter is measured by means of any protocol that may be available to a person skilled in the art. Preferably, the following “desiccation” method is used:
The sample is first weighed and a mass m1 is measured in grams.
The water is evaporated off by placing the sample in a heated chamber until the mass of the sample has stabilized, the water being completely evaporated off. Preferably, the temperature is 105° C. under atmospheric pressure.
The final sample is weighed and a mass m2 is measured in grams.
Dry matter=(m2/m1)×100

In a preferred embodiment, the content of total protein of the corn steep powder is between 20% and 40%, preferentially between 27% and 33%, the percentages being on a dry matter basis.

The content of total protein may be determined by any protocol well known to those skilled in the art, for instance assay of the total amount of amino acids. Preferentially, the total nitrogen will be assayed according to the Dumas method and the value will be multiplied by a coefficient of 6.25.

Finally, the invention relates to the use of this soluble corn steep in any industry, in particular in the large-scale fermentation industries.

The corn steep powder in accordance with the invention may advantageously be used as a nutritive substance in the preparation of culture media for the fermentation industries. It may also be used in the food or animal nutrition fields or other fields.

Beside its sterilization stability and in contrast with the corn steep powders of the prior art, the corn steep in accordance with the invention conserves its initial biochemical characteristics. Furthermore, it is advantageously compressible, which is particularly attractive in industrial practice, due to the risks and drawbacks related to the handling of powders. Furthermore, the tablet form enables precise dosage during the preparation of culture media.

The invention will be better understood by means of the following examples, which are not intended to be limiting and merely present some of the embodiments and some of the advantageous properties of the corn steep powder according to the invention.

### EXAMPLES

### Example 1

### Production of the Corn Steep Solution According to the Prior Art EP

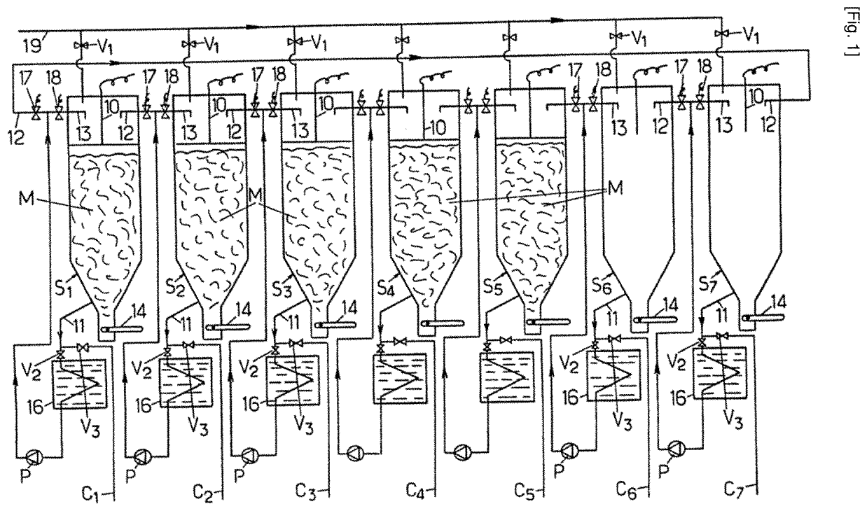

For the production of corn steep liquor, an array of silos is used (FIG. 1) composed of seven stainless-steel silos S1 to S7, having a bottom filter, a total volume of 33 litres and a diameter of 25 cm, which can be filled with corn M and which are each equipped with:
a level probe 10,
a pipe system 11 connecting the bottom of a given silo, on the one hand, to the head of the next silo via a line 12 and, on the other hand, to the head of the silo itself via a line 13 for the recirculation of the liquid phase in the silo itself or toward the next silo, this pipe system also being used for drawing off the steeping water when desired,
a large-diameter underflow gate 14 for emptying out the corn,
a water bath 16 which is temperature-regulated with just as many circulating pumps P for the circulation of the liquid phase from a given silo through the heating coil to the next silo or to the head of the silo under consideration,
seven sets of two solenoid valves 17 and 18 placed, respectively, on the pipe systems 12 and 13, and controlled by the level probe (ensuring that the corn is perfectly covered and the liquid is moving through the array of silos),
a line 19 for the inflow of water containing sulfite, adjusted to 1.5 g/L of sulfur dioxide, from which the water containing sulfite is distributed at a constant flow rate, ensuring a constant circulation level (litres of water per kg of corn), successively on each silo, through the aperture of the corresponding valve V1,
a 20-litre tank (not shown) collecting the steeping water from the silos before grinding the corn, and connected to each of the silos via, respectively, the lines C1 to C7 branched onto the lines 11 of each silo, the direction of the steeping water exiting a given silo to the pipe system 11 or the line C being provided, respectively, by a valve V2 and V3,
an evaporator (not shown) of the type sold by Kurt Herbert Apparate and Maschinenbau Lahr, Baden. Each day, the collected steeping water is evaporated to 50% of dry matter using this vacuum evaporator, at a temperature below 60° C.

The corn used is French corn, which comes from the usual suppliers from the starch industry. The steeping time chosen is 40 hours and the SO2 content is set at 1.5 g/litre.

The temperature is set at 48° C.±1° C. throughout the array of silos. The time of 40 hours is obtained for an operation on five silos with emptying every 8 hours.

The level of water circulation was gradually raised from 0.8 to 1.0-1.5 and 1.8 litres of water per kg of commercial corn.

Attempts are then made to atomize the corn steep liquor or steeping water thus obtained, in a Niro tower, under the following conditions: inlet temperature, 200° C.—outlet temperature, 96° C.—turbine speed, 15 000 rpm—evaporation capacity, 80 litres/hour.

It was impossible, even by varying the parameters, to obtain satisfactory atomization. The powder quickly and strongly sticks to the atomizing chamber, creating a layer of product. The atomization process is rapidly disrupted by this layer of product, and cannot be maintained over time. It is impossible to consider industrial scaling-up.

### Example 2

### Treatment of the Corn Steep Solution with a Salt of Divalent Cations

A corn steep solution containing 50% dry matter is prepared by performing the process described in Example 1, and it is then concentrated using a vacuum evaporator. Next, 3.2% by weight (dry/dry) of a salt of divalent cations MgO is added thereto in the form of a 100 g/I suspension, in a tank with the temperature regulated to 50° C. and with stirring.

The pH of the MgO-enriched corn steep liquid thus obtained is 5.7.

Next, atomization is performed in a Niro tower, under the following conditions: inlet temperature, 200° C.—outlet temperature, 96° C.—turbine speed, 15 000 rpm—evaporation capacity, 80 litres/hour.

The lactic acid content of the corn steep obtained is 14% by weight. The particles do not adhere to the atomization chamber walls. The powder is dense and flows down rapidly from the cyclone.

### Example 3

### Corn Steep Solution Subjected to a Step of Adjustment to pH 7

A corn steep liquid containing 50% dry matter is prepared by performing the process described in Example 1.

The necessary amount of ammonium hydroxide (NH4OH) is then added thereto, in a tank with the temperature regulated to 50° C. and with stirring, to obtain a pH of 7.

After stirring for 10 min, the corn steep solution is sent to a PS ultrafiltration membrane, having a cut-off threshold of 30 kDa, placed in a cross-flow filtration skid.

Next, atomization is performed in a Niro tower, under the following conditions: inlet temperature, 200° C.—outlet temperature, 96° C.—turbine speed, 15 000 rpm—evaporation capacity, 80 litres/hour.

It was impossible, even by varying the parameters, to obtain satisfactory atomization. The powder quickly and strongly sticks to the atomizing chamber, creating a layer of product. The atomization process is rapidly disrupted by this layer of product, and cannot be maintained over time. It is impossible to consider industrial scaling-up.

### Example 4

### Treatment of the Corn Steep Solution According to the Invention

A corn steep liquid containing 50% dry matter is prepared by performing the process described in Example 1.

After dilution to 15%, 5% w/w of potassium hydroxide (50%) and 4.2% w/w of MgSO4 are added thereto, in a tank with the temperature regulated to 40° C. and with stirring, so as to obtain a pH of 7. Alternatively, addition of 3.5% w/w of ammonium hydroxide (20.5%) and 4.2% w/w of MgSO4 may be performed.

After stirring for 10 min, the corn steep solution is cooled to 20° C. and then fed to a plate centrifuge, of the Westfalia Separator NA7 type in “continuous sediment removal” configuration, i.e. as a nozzle separator. The separator is equipped with four 0.3-mm ejection nozzles. The speed of the bowl is 8400 rpm, the acceleration is estimated to be of about 6000 g. The separator is fed at a flow rate of about 250 I/h with a back pressure of 0.5 bar.

The supernatant is then directly dried by atomization. The atomization is performed in a Niro tower, under the following conditions: inlet temperature, 200° C.—outlet temperature, 96° C.—evaporation capacity, 20 litres/hour.

### Example 5

### Comparison of the Stability Towards Sterilization of the Various Corn Steep Solutions

The stability towards sterilization of the various products obtained in the preceding examples was compared. Specifically, an insoluble precipitate appears in the corn steep liquor of the prior art when it is subjected to a schedule of sterilization which is conventional in the fermentation industry. The test for comparing the various samples is as follows:

The corn steep liquor is first adjusted to pH 7±0.5 with HCl and NaOH. Said corn steep liquor is then photographed. The percentage of insoluble particles is measured according to the following test A:
200 g of the corn steep liquor are placed in a 500 ml conical flask closed with a foam stopper covered with aluminium foil.
The conical flask is sterilized using a wet steam autoclave, following a schedule of 20 minutes at 121° C.
The corn steep liquor is then filtered through a cellulose acetate filter with a porosity of 0.22 micron, the weight of which is known.
The filter is freeze-dried, then its weight is measured. The filter is tared, which makes it possible to determine the amount of insoluble matter which has appeared, after drying the filter under vacuum.
The percentage of insoluble particles (in %)=((weight of dried final filter−weight of initial filter)/initial weight of corn steep solution)×100.

The corn steep filter is photographed for the purpose of comparison with the values obtained in step 1.

Table 1 below summarizes the relative performance of the various corn steep liquors presented in the above examples:

TABLE 1

| | Example 1 | Example 2 | Example 3 | Example 4 |
|---|---|---|---|---|
| | Conventional | Corn steep | Corn steep | Corn steep |
| | corn steep | liquor with | liquor with | liquor with |
| | liquor | addition of | addition of | addition of |
| | | MgO | NH4OH and | MgSO4, |
| | | | UF | filtration |
| Atomization | Not OK | OK | Not OK | OK |
| (OK/Not OK) | | | | |
| Percentage of | 15.60% | 12.30% | 0.80% | 0.40% |
| insoluble | | | | |
| particles | | | | |
| according to | | | | |
| Test A (in %) | | | | |

As explained in the description section, treatment of the corn steep solution according to the invention is the only treatment which allows easy atomization of the solution while limiting the appearance of a precipitate after sterilization (less than 1% according to the test described above).

### Example 6

### Comparison of the Efficacy of the Various Corn Steep Liquors in Fermentation

The reference strain here is Lactobacillus delbrueckii.

The preculture is prepared in 100 ml of MRS medium (Man-Rogosa-Sharpe agar) comprising cysteine in a 250 ml conical flask with stirring, under anaerobic conditions at 37° C. and at pH 6.8-7.

When the preculture is finished, a 3 litre fermenter is seeded with 1000 ml comprising 50 WI of glucose, 3-1 g/l K2HPO4-KH2PO4, 0.5 g/l MgSO4.7H2O, and 1 g/l of Tween 80 as final concentrations.

The amount of corn steep is then added (0.5 g/l). Culturing is performed at a temperature of 37° C. and a pH first regulated to 6.4 with 5N NaOH and anaerobic conditions under an inert atmosphere of nitrogen.

The colonies are counted (performed by culturing in Petri dishes and expressed as cfu/ml) during the fermentation so as to ensure comparative performance of the various corn steep solutions produced in the above examples.

The counting results are indicated in Table 2 below:

TABLE 2

| Fermentation | Corn steep | Corn steep | Corn steep | Corn steep |
|---|---|---|---|---|
| time (h) | Example 1 | Example 2 | Example 3 | Example 4 |
| 0 | 4.77 × 10⁶ | 3.57 × 10⁶ | 3.66 × 10⁶ | 3.75 × 10⁶ |
| 4 | 2.30 × 10⁷ | 2.05 × 10⁷ | 1.25 × 10⁷ | 2.29 × 10⁷ |
| 8 | 1.21 × 10⁸ | 9.90 × 10⁷ | 7.22 × 10⁷ | 1.01 × 10⁸ |
| 23 | 3.57 × 10⁸ | 1.88 × 10⁸ | 1.00 × 10⁸ | 3.62 × 10⁸ |
| 28 | 4.00 × 10⁸ | 2.66 × 10⁸ | 1.12 × 10⁸ | 3.99 × 10⁸ |

1-9. (canceled)

10. A process for treating a corn steep solution, comprising the following steps:
a) addition of neutral salts of divalent cations to the corn steep solution;
b) adjustment of the pH of the corn steep solution to a value of between 6 and 8;
c) separation of the liquid and solid phases of the solution obtained in step b);
d) drying of the liquid phase obtained in step c) in order to obtain a corn steep powder.

11. The process according to claim 10, wherein the neutral salts of divalent cations are salts of magnesium or calcium, preferentially calcium sulfate or magnesium sulfate.

12. The process according to claim 10, wherein the neutral salts of divalent cations are added to the corn steep solution brought to a temperature of between 20 and 60° C.

13. The process according to claim 10, wherein the pH is adjusted to between 6 and 8 by adding potassium hydroxide or ammonium hydroxide.

14. The process according to claim 10, wherein the separation of the liquid and solid phases in step c) is performed by plate centrifugation.

15. The process according to claim 10, wherein the drying in step d) is performed by atomization.

16. The process according to claim 10, wherein the amount of divalent salts is between 0.5 and 3.5 mol/kg of dry matter of the corn steep solution, preferably between 1 and 3 mol/kg of dry matter of the corn steep solution, even more preferentially 1.5 mol/kg of dry matter of the corn steep solution.

17. A corn steep powder which may be obtained via the process according to claim 10.

18. The corn steep powder according to claim 17, wherein the amount of protein is between 20% and 40%, preferably between 27% and 33% of the dry matter weight of the corn steep powder.
